(19) United States
(12) Patent Application Publication
(10) Pub. No.: US 2006/0062108 A1
(43) Pub. Date: Mar. 23, 2006

(54) Sensing light emitted from multiple light sources

(75) Inventor: Subramanian Muthu, Schaumburg, IL (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, Eindhoven (NL)

(21) Appl. No.: 10/539,979

(22) PCT Filed: Dec. 12, 2003
(86) PCT No.: PCT/IB03/05973

§ 371 Date: Jun. 19, 2005

Related U.S. Application Data
(60) Provisional application No. 60/435,244, filed on Dec. 20, 2002.

(51) Int. Cl. G11B 7/00

(52) U.S. Cl. 369/44.34; 369/53.1

(57) ABSTRACT

A method is directed to sensing individual intensity of a plurality of light sources. The method provides for transmitting a command signal to each of the light sources, sequentially activating the light sources based on the command signals, and determining an intensity value for each light source. The method may further include determining a control signal based on the intensity value of each light source and controlling the light sources with the control signal. Sequentially activating the light sources may include activating each light source individually for a predetermined activation period within an activation cycle. Determining the intensity value for each light source may include receiving each light signal individually during the sequential activating period, processing the received light signals, and producing the intensity value for each light source based on the processed light signals.

The technical field of this disclosure is light production from light emitting diodes (LEDs), particularly, sensing light emitted simultaneously from multiple light sources.

Illumination sources, such as lamps, currently utilize incandescent and fluorescent means as light production. It is well known that incandescent light sources are inefficient light sources that utilize more power resources than other light sources. Fluorescent light sources have provided a more efficient light production.

Light emitting diodes (LEDs) produce light in a much more efficient manner but until recently have not been manufactured in a cost efficient manner to utilize in lighting applications. Recently, LED production has made utilizing LEDs in light production applications a viable alternative.

Producing usable light with LEDs generally requires either manufacturing an LED that produces a specified color, such as utilizing a phosphor layer overlying the LED, or mixing a plurality of colored LEDs to produce a desired colored light output. Unfortunately, once a light source package is produced to achieve the desired colored light output its useful life is reduced to the amount of time until a failure or partial failure of one of its component parts occurs.

It would be desirable, therefore, to provide a system that would overcome these and other disadvantages.

One aspect of the invention provides a method for sensing individual intensity of a plurality of light sources. The method includes transmitting a command signal to each of the light sources, sequentially activating the light sources based on the command signals, and determining an intensity value for each light source.

In accordance with another aspect of the invention, a computer readable medium storing a computer program includes: computer readable code for transmitting a command signal to each of the light sources; computer readable code for sequentially activating the light sources based on the command signals; and computer readable code for determining an intensity value for each light source.

In accordance with yet another aspect of the invention, a system for sensing intensity of a light source is provided. The system includes a plurality of light sources. The system further includes means for sequentially activating the light sources for a predetermined period of time. Means for determining an intensity value for each of the light sources is also provided.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

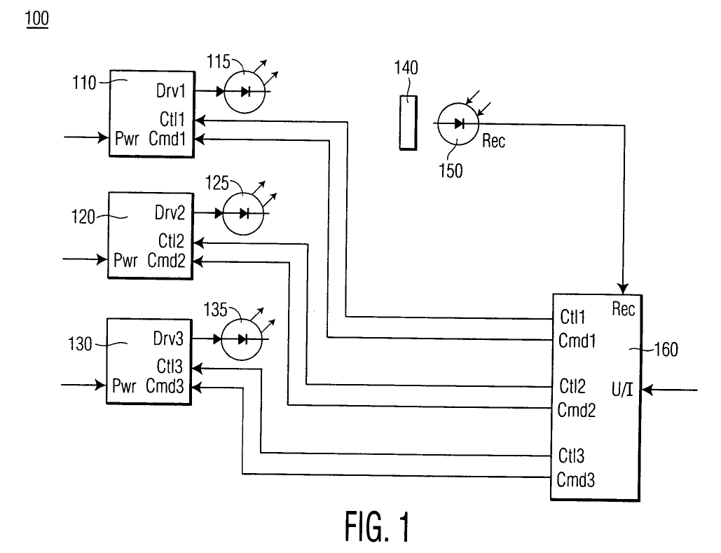

FIG. 1 is a schematic diagram illustrating a control device according to an embodiment of the present invention;

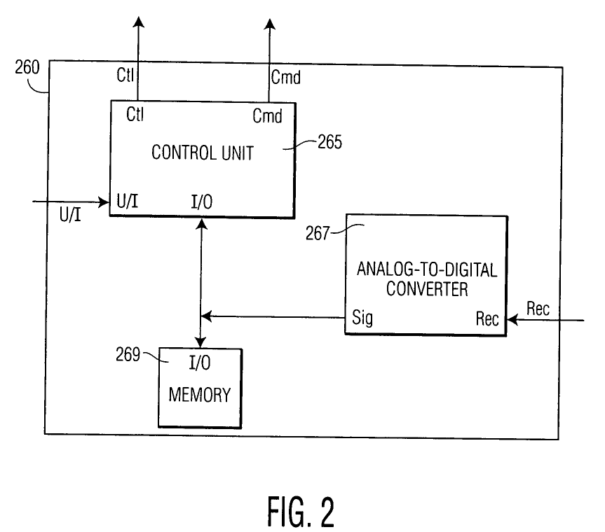

FIG. 2 is a schematic diagram illustrating a portion of the control device in FIG. 1 according to an embodiment of the present invention;

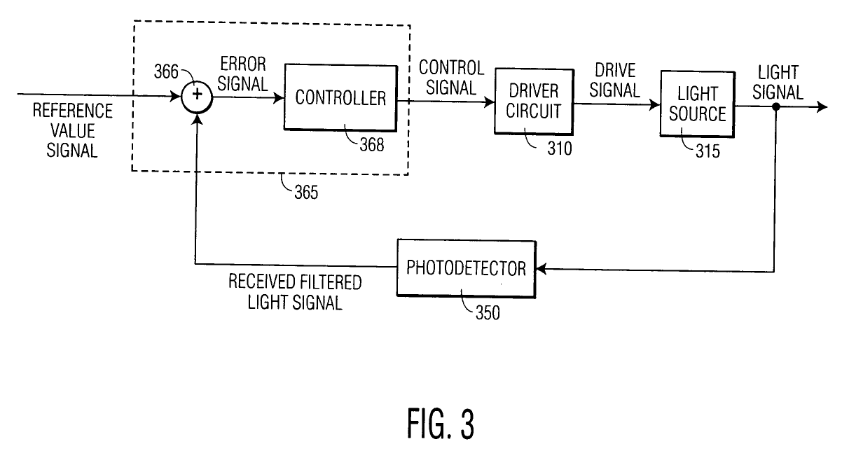

FIG. 3 is a schematic diagram illustrating another portion of the control device in FIG. 1 according to an embodiment of the present invention; and

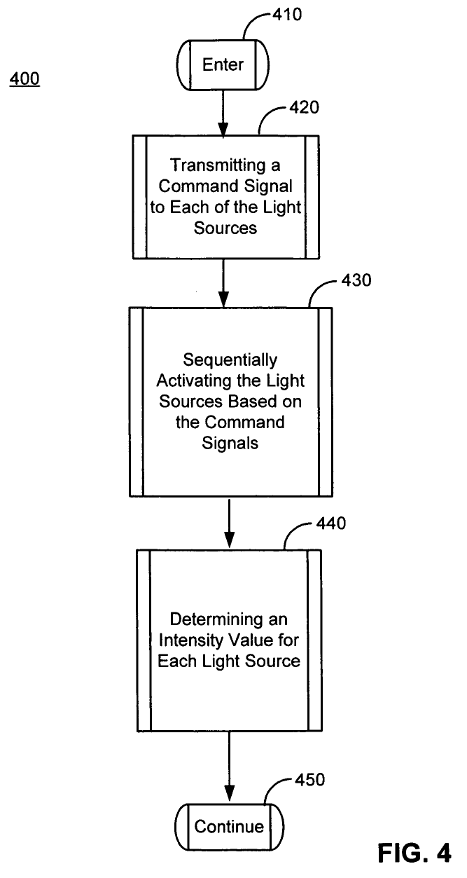

FIG. 4 is a flow diagram depicting an exemplary method in accordance with the present invention.

Throughout the specification, and in the claims, the term “connected” means a direct physical or optical connection between the things that are connected, without any intermediate devices. The term “coupled” means either a direct physical or optical connection between the things that are connected or an indirect connection through one or more passive or active intermediary devices. The term “circuit” means either a single component or a multiplicity of components, either active or passive, that are coupled together to perform a desired function.

FIG. 1 is a schematic diagram illustrating a control device 100 according to an embodiment of the present invention. Control device 100 includes control units (110, 120, and 130), light emitting diodes (115, 125 and 135), a filter 140, a photodetector 150, and a processor 160. In one embodiment, implementation of the present invention allows any number of light emitting diodes (LEDs) to be utilized, so long as there is a corresponding filter for each LED spectral output. The combining of the LEDs into a functional unit is referred to as a light source. Each LED may represent a single LED or a group of LEDs with like spectral outputs characteristics.

In an example and referring to FIG. 1, control device 100 is implemented as a plurality of LEDs, each LED having a portion of filter 140 associated with the LED spectral output. In this example, emitted spectra of the LEDs form a multi-source light signal. For example, a red, a green, and a blue LED are utilized to produce a “white” multi-source light signal. Additionally, an amber LED may be utilized in addition to or instead of one of the above listed color LEDs, for example as a substitution for or in addition to the red LED. Other color LEDs may be utilized in the implementation as well.

Each control unit (110, 120, and 130) includes an associated output drive signal terminal (Drv1, Drv2, and Drv3), an associated input control terminal (Ctl1, Ctl2, and Ctl3), an associated input command terminal (Cmd1, Cmd2, and Cmd3), and an input power terminal. Each control unit (110, 120, and 130) receives an associated control signal, an associated command signal, and a power signal. Each control unit (110, 120, and 130) produces an associated drive signal based on the received control signal, command signal, and power signal. Each output drive signal terminal (Drv1, Drv2, and Drv3) is coupled to an associated light emitting diode (115, 125 and 135). Alternatively, the control signal and the command signal can be transmitted to each control unit utilizing a single terminal.

In an example, output drive signal terminal (Drv1) is coupled to light emitting diodes (115), output drive signal terminal (Drv2) is coupled to light emitting diode (125), and output drive signal terminal (Drv3) is coupled to light emitting diode (135). LEDs may represent groups of similar LEDs.

In one embodiment, the power signal is implemented as a voltage source signal. In another embodiment, the power signal is implemented as a current source signal. In an example, each control unit (110, 120, and 130) produces a drive signal including a current signal modulated at a specific frequency.

The power signal may be produced in the form of one of several different waveforms, such as, for example, a square wave implemented as pulse width modulation, amplitude modulation, pulse amplitude modulation, or any other waveform that would allow the production of the light signal.

Light emitting devices (115, 125 and 135) are optoelectronic devices that produce light when power is supplied to them. The light produced may be within the blue, green, red, or amber spectrum, depending on the material utilized in manufacturing the LED. In an example, LEDs (115, 125 and 135) are implemented as luxeon emitters LXHL-PD01 (Red), LXHL-PM01 (Green), and LXHL-PB01 (Blue) available from Lumileds of San Jose, Calif. In another example, LEDs (115, 125 and 135) are implemented as an SMD amber LED HSMA-C170 available from Agilent of Palo Alto, Calif., a Green LED NECG310, and Blue LED NECB310 available from Nichia of Mountville, Pa.

Each control unit produces a drive signal based on the control signal and the command signal. Power, in the form of the drive signal, is transmitted to the associated light emitting diode (LED). The LED receives the drive signal and produces a light signal based on the drive signal. The light signal includes an intensity value within the LED's spectral band at a specified frequency and based on the control signal. Multiple control units and associated LEDs produce a light signal including several spectral intensity values, each intensity value operating at the specified frequency. In an example, a specified frequency of 200 Hz is utilized so light output does not appear to flicker when observed by a human eye.

Filter 140 is an optical filter, optically coupled to LEDs (115, 125 and 135), that filters light signals and produces filtered light signals. In one embodiment, filter 140 is implemented as a multi-sectioned filter. In this embodiment, the number of sections of the multi-sectioned filter corresponds to the number of LEDs utilized. In an example, a three LED output light signal produces a multi-source light signal having light in the red, green, and blue spectra. The multi-source light signal results in a three-sectioned filter with corresponding red, green, and blue filter sections.

Photodetector 150 is an optoelectronic device optically coupled to filter 140 that responds to light signals and produces a received light signal. For example, photodetector 150 receives a filtered light signal from filter 140 and produces a received filtered light signal. In one embodiment, photodetector 150 is implemented as a photodiode, such as, for example a photodio BPW33 available from Osram of Munchen, Germany. Photodetector 150 includes an output signal terminal (Rec) for supplying the received light signal. In an example, photodetector 150 responds to a multi-source filtered light signal and produces a received filtered light signal at the output signal terminal (Rec). In one embodiment, photodetector 150 is implemented as a single photodiode.

Processor 160, detailed in FIG. 2 below, includes an input signal terminal (Rec) and an input user-interface terminal (U/I). Processor 160 further includes output control terminals (Ctl1, Ctl2, and Ctl3) and output command terminals (Cmd1, Cmd2, and Cmd3). The input signal terminal (Rec) of processor 160 is coupled to the output signal terminal (Rec) of photodetector 150.

Each output control terminal (Ctl1, Ctl2, and Ctl3) of processor 160 is coupled to the input control terminal (Ctl1, Ctl2, and Ctl3) of each associated control unit (110, 120, and 130). Each input command terminal (Cmd1, Cmd2, and Cmd3) of processor 160 is coupled to the input command terminal (Cmd1, Cmd2, and Cmd3) of each associated control unit (110, 120, and 130).

In an example, output control terminal (Ctl1) of processor 160 is coupled to input control terminal (Ctl1) of control unit 110, output control terminal (Ctl2) of processor 160 is coupled to input control terminal (Ctl2) of control unit 120, and output control terminal (Ctl3) of processor 160 is coupled to input control terminal (Ctl3) of control unit 130.

In operation, control units (110, 120, and 130) each receive an associated control signal including an intensity value applicable to the associated LED and a frequency, for example 200 Hz. Additionally, control units (110, 120, and 130) each receive an associated command signal sequentially activating each LED for a predetermined activation period within an activation cycle. In an example, each LED is sequentially activated for a 200 μs activation period within a 5 ms (200 Hz) activation cycle. The LEDs emit a light signal including a light output from each of the LEDs associated with the control units (110, 120, and 130).

The emitted light signal is filtered by filter 140. In an example, filter 140 is a multi-sectioned filter having a number of sections equal to the number of LEDs. Each section of the multi-sectioned filter filters a portion of the light spectrum.

Filter 140 is optically coupled to photodetector 150 and communicates a multi-source filtered light signal to photodetector 150. Photodetector 150 responds to a multi-source filtered light signal and produces a received filtered input signal. In an example, the received filtered input signal includes an intensity value for each light source of the multi-source light signal. In another example, the filtered input signal is a filtered light signal.

Processor 160 is coupled to photodetector 150 and receives a filtered input signal, at the input signal terminal (Rec), from photodetector 150. Additionally, processor 160 receives a user input signal, at the user-interface terminal (U/I), identifying a specific mixture of light output from the LEDs.

In one embodiment, a user-interface (not shown) supplies a desired target color to be generated by the light source. The user interface can be implemented in many embodiments, such as, for example a digital addressable lighting interface (DALI), an analog interface, a wireless interface, and the like. In an example, the user interface supplies target color information and is coupled to processor 160. In another example, the user interface is coupled to memory 269, detailed in FIG. 2 below.

Processor 160 produces a control signal for each LED, at the associated output control terminal (Ctl1, Ctl2, and Ctl3), based on the received filtered input signal and user input signal. Additionally, processor 160 produces a command signal for each LED, at the associated output command terminal (Cmd1, Cmd2, and Cmd3).

In a further embodiment, control device 100 includes an amplifier to amplify the received filtered input signal, and a device for conditioning the received filtered input signal. In this embodiment, the amplifier and conditioning device is coupled between the output signal terminal (Rec) of photodetector 150 and the input signal terminal (Rec) of processor 160. In an example, coupling an amplifier and conditioning device between the photodetector and the processor produces a more desirable received filtered input signal.

FIG. 2 is a schematic diagram illustrating a portion of the control device in FIG. 1 according to an embodiment of the present invention. Processor 260 includes a control unit 265, an analog-to-digital converter (ADC) 267, a memory device 269, an output control terminal (Ctl), an output command terminal (Cmd), an input signal terminal (Rec), and user-interface terminal (U/I). Processor 260 receives a filtered input signal and a user input signal, produces a command signal, and produces a control signal based on the filtered input signal and a user input signal.

Analog-to-digital converter (ADC) 267 includes an input signal terminal (Rec) and an output signal terminal (Sig). ADC 267 receives the filtered input signal and produces a digitized input signal based on the received filtered input signal. ADC 267 may be implemented as any such device utilized throughout the industry and may be integrated within processor 260.

Memory 269 includes an input/output terminal (I/O). The input/output terminal (I/O) of memory 269 is coupled to the output signal terminal (Sig) of ADC 267 and input/output terminal (I/O) of control unit 265. Memory 269 provides instructions to control unit 265 and stores data produced by ADC 267 and control unit 265. In an example, data stored within memory 269 includes data associated with the digitized input signal produced by ADC 267. In another embodiment and referring to FIG. 1 above, data stored within memory 269 includes signals that correspond to a target color received from the user-interface (not shown).

Memory 269 may be implemented as any such device utilized throughout the industry, such as, for example random access memory (RAM), read only memory (ROM), and may be integrated within processor 260.

Control unit 265 includes an input/output terminal (I/O), a user-interface terminal (U/I), an output control terminal (Ctl), and an output command terminal (Cmd). The input/output terminal (I/O) of control unit 265 is coupled to the input/output terminal (I/O) of memory 269.

Control unit 265 receives a digitized input signal from ADC 267, instructions from memory 269, and a user input signal. Control unit 265 produces a command signal, and produces a control signal based on the filtered input signal, the instructions, and a user input signal.

FIG. 3 is a schematic diagram illustrating another portion of the control device in FIG. 1 according to an embodiment of the present invention. FIG. 3 illustrates an embodiment of a control function within control unit 265 of processor 260. FIG. 3 includes driver circuit 310, light source 315, photodetector 350, and control unit 365. Photodetector 350 includes a filter described in FIG. 1, above. Control unit 365 includes error sensing device 366 and controller 368.

Driver circuit 310 is coupled to control unit 365 and receives a control signal from control unit 365. Driver circuit 310 produces a drive signal based on the received control signal.

Light source 315 is coupled to driver circuit 310 and receives the drive signal from driver circuit 310. Light source 315 produces a light signal based on the received drive signal.

Photodetector 350 is optically coupled to light source 315 and receives the light signal from light source 315. Photodetector 350 receives the light signal, filters the received light signal, and produces a received filtered light signal, also called a received filtered input signal.

Control unit 365 is coupled to photodetector 350 and receives the filtered input signal from photodetector 350. Control unit 365 also receives a reference value signal. In one embodiment, the reference value signal is obtained from a look up table based on user input. In an example and referring to FIGS. 1 and 2 above, user input is received from a user-interface at the U/I terminal. In this example, the look-up table is contained within memory 269. Control unit 365 produces the control signal based on the received filtered light signal and the reference value signal.

Control unit 365 includes error sensing device 366 that is coupled to photodetector 350. Error sensing device 366 receives the received filtered light signal from photodetector 350 and the reference value signal. Error sensing device 366 produces an error signal based on the received filtered light signal and the reference value signal.

Control unit 365 additionally includes controller 368 that is coupled to error sensing device 366. Controller 368 receives the error signal and produces the control signal based on the error signal.

In operation and referring to FIG. 2 above, each reference value signal includes a reference value and the received filtered input signal is a digitized input signal. In one embodiment, the reference value of each LED is obtained at the time of factory calibration.

In an example, the reference value is obtained by utilizing a standard spectrometer measuring color and intensity of light output of the LED. The LED drive currents are simultaneously adjusted to reach the target color point and intensity. Upon reaching the desired color point and intensity, the individual contribution of the LED, in the output of the sensor, is measured. The value is then set as the reference value corresponding to the target color. In another example, additional reference values are similarly obtained corresponding to different target colors and are stored in a lookup table.

The difference between a portion of the digitized input signal associated with a particular LED and the reference value associated with the LED is utilized by error sensing device 366 to determine an error signal. The error signal is then utilized by controller 368 to produce a control signal.

In one embodiment, controller 368 is implemented as a proportional-integral (PI) controller. In an example and utilizing a standard RGB light source, the controller adjusts the control voltage to the Red LED driver which in turn adjusts the Red LED forward current in such a way to make the error between the reference signal and the filtered input signal output to zero. When this occurs, the system is said to have reached a steady-state condition.

In one embodiment and referring to FIGS. 2 and 3, control unit (265, 365) includes an error sensing device 366 and controller 368 for each LED. In another embodiment, control unit (265, 365) includes a single error correction device 366 and controller 368 for the system.

FIG. 4 is a flow diagram depicting an exemplary method for sensing individual intensity of a plurality of light sources in accordance with the present invention. Method 400 may utilize one or more systems detailed in FIGS. 1-3, above.

Method 400 begins at block 410 where a control system for a light source determines a need to sense individual intensity of a plurality of light sources, such as light emitting diodes (LEDs). Method 400 then advances to block 410.

Method 400 then transmits a command signal to each of the light sources (block 420). In one embodiment and referring to FIGS. 1 and 2, processor (160 and 260) produces a command signal for each of the control units (110, 120, and 130) that control an associated LED (115, 125 and 135) and transmits the command signal to the control units (110, 120, and 130).

Method 400 then sequentially activates the light sources based on the command signals (block 430). The command signal is designed to sequentially activate each light source individually for a predetermined activation period within an activation cycle. In an example, each LED is sequentially activated for a 20 μs activation period within a 5 ms (200 Hz) activation cycle. That is, a three LED RGB light source command signal would activate the red LED for 200 μs, followed by activating the green LED for 200 μs, followed by activating the blue LED for 200 μs and repeating the process every 5 ms (200 Hz). While each of the individual LEDs is activated, the two inactivated LEDs remain are momentarily deactivated.

Method 400 then determines an intensity value for each light source (block 440). In one embodiment and referring to FIGS. 1 and 2, the intensity value is determined by receiving each light signal individually during the sequential activating period, processing the received light signals, and producing the intensity value for each light source based on the processed light signals.

Receiving the light signals includes filtering each light signal individually during the sequential activating period, collecting the filtered light signals, and passing the collected light signals for processing. In one embodiment, filtering each light signal is implemented utilizing filter 140 of FIG. 1, above.

In another embodiment, collecting the filtered light signals is implemented utilizing photodetector 150 of FIG. 1, above. For example, photodetector 150 can be implemented as a photo diode, such as, BPW33 manufactured by Osram of Munchen, Germany.

Processing the received light signals includes converting the received light signals to digital light signals and analyzing the digital light signals to determine the intensity value for each light source. In one embodiment, converting the received light signals to digital light signals is implemented utilizing analog-to-digital converter (ADC) 267 of FIG. 2, above. In an example, (ADC) 267 is integrated within processor 260.

In another embodiment, analyzing the digital light signals to determine the intensity value for each light source is implemented utilizing control unit 265 and memory device 269 of FIG. 2, above. In an example, control unit 265 and memory device 269 is integrated within processor 260.

Analyzing the received light signals includes comparing the digital light signals to a reference value and determining the intensity value based on the comparison. In one embodiment, comparing the digital light signals to a reference value control unit 265 and memory device 269 of FIG. 2, above. In this embodiment and described in FIG. 2, the reference value is contained within memory device 269 in addition to instructions allowing control unit 265 to conduct the comparison. In an example, memory device 269 includes a look-up table including data for the comparison.

The control system utilizes the intensity values to determine the amount of power to supply to the LEDs of the light source. In one embodiment and referring to FIGS. 1 and 2, the control system determines power adjustment requirements by cross indexing each provided LED intensity value with a thermal value (already received). In an example, each provided LED intensity value and thermal value are cross indexed in a look-up table that includes manufacturer provided data. The resultant intensity value obtained from the look-up table, for each LED, is then utilized by the control system to determine an actual contribution of each LED to the light source. Power supplied to each LED is then adjusted accordingly.

The above-described method and system for sensing individual intensity of a plurality of light sources are example methods and implementations. These methods and implementations illustrate one possible approach for sensing individual intensity of a plurality of light sources. The actual implementation may vary from the method discussed. Moreover, various other improvements and modifications to this invention may occur to those skilled in the art, and those improvements and modifications will fall within the scope of this invention as set forth in the claims below.

The present invention may be embodied in other specific forms without departing from its spirit or essential characteristics. The described embodiments are to be considered in all respects only as illustrative and not restrictive.

1. A method for sensing individual intensity of a plurality of light sources, comprising:
transmitting a command signal to each of the light sources;
sequentially activating the light sources based on the command signals; and
determining an intensity value for each light source.

2. The method of claim 1, wherein sequentially activating the light sources comprises:
activating each light source individually for a predetermined activation period within an activation cycle.

3. The method of claim 1, further comprising:
determining a control signal based on the intensity value of each light source; and
controlling the light sources with the control signal.

4. The method of claim 1, wherein determining the intensity value for each light source comprises:
receiving each light signal individually during the sequential activating period;
processing the received light signals; and
producing the intensity value for each light source based on the processed light signals.

5. The method of claim 4, wherein receiving the light signals comprises:
filtering each light signal individually during the sequential activating period;
collecting the filtered light signals; and
passing the collected light signals for processing.

6. The method of claim 5, wherein filtering each activated light signal is accomplished utilizing a multi-sectioned filter.

7. The method of claim 6, wherein the multi-sectioned filter includes a number of sections of at least the number of light sources.

8. The method of claim 6, wherein each section of the multi-sectioned filter is designed to filter a spectral portion of the light signals.

9. The method of claim 5, wherein the steps of filtering and collecting the light signals are accomplished utilizing a filter coupled to a single photodiode.

10. The method of claim 4, wherein processing the received light signals comprises:
converting the received light signals to digital light signals; and
analyzing the digital light signals to determine the intensity value for each light source.

11. The method of claim 10, wherein analyzing the received light signals comprises:
comparing the digital light signals to a reference value; and
determining the intensity value based on the comparison.

12. The method of claim 11, wherein the reference value is a predetermined value.

13. A computer readable medium storing a computer program comprising:
computer readable code for transmitting a command signal to each of the light sources;
computer readable code for sequentially activating the light sources based on the command signals; and
computer readable code for determining an intensity value for each light source.

14. The computer readable medium of claim 13, wherein computer readable code for sequentially activating the light sources based on the command signals comprises:
computer readable code for activating each light source individually for a predetermined activation period within an activation cycle.

15. The computer readable medium of claim 13, further comprising:
computer readable code for determining a control signal based on the intensity value of each light source; and
computer readable code for controlling the light sources with the control signal.

16. The computer readable medium of claim 13, wherein computer readable code for determining the intensity value for each light source comprises:
computer readable code for receiving each light signal individually during the sequential activating period;
computer readable code for processing the received light signals; and
computer readable code for producing the intensity value for each light source based on the processed light signals.

17. The computer readable medium of claim 14, wherein the computer readable code for processing the received light signals comprises:
computer readable code for converting the received light signals to digital light signals; and
computer readable code for analyzing the collected light signals to determine the intensity value for each light source.

18. The computer readable medium of claim 15, wherein the computer readable code for analyzing the received light signals comprises:
computer readable code for comparing the digital light signals to a reference value; and
computer readable code for determining the intensity value based on the comparison.

19. The computer readable medium of claim 16, wherein the reference value is a predetermined value.

20. A system for sensing intensity of a light source:
a plurality of light sources;
means for sequentially activating the light sources for a predetermined period of time; and
means for determining an intensity value for each of the light sources.
